(19) United States
(12) Patent Application Publication
(10) Pub. No.: US 2013/0139498 A1
(43) Pub. Date: Jun. 6, 2013

(54) CONTROL APPARATUS FOR A FIRST TOOL AND A SECOND TOOL

(71) Applicants: Wolfgang Bertleff, Erlangen (DE); Carsten Sauerbier, Lauf an der Pegnitz (DE)

(72) Inventors: Wolfgang Bertleff, Erlangen (DE); Carsten Sauerbier, Lauf an der Pegnitz (DE)

(73) Assignee: LUKAS HYDRAULIK GMBH, Erlangen (DE)

(21) Appl. No.: 13/816,449

(22) PCT Filed: Aug. 10, 2011
(86) PCT No.: PCT/EP11/03997

§ 371 Date: Feb. 11, 2013

(30) Foreign Application Priority Data
Aug. 12, 2010 (DE) 10 2010 034 187.8

(51) Int. Cl. F15B 11/17

(52) U.S. Cl. CPC F15B 11/17
USPC 60/484

(57) ABSTRACT

A control apparatus for a first and a second tool (1, 2) operated by means of a pressure medium, in particular hydraulic oil, includes a first supply circuit (3) for the first tool (1) and a second supply circuit (4) for the second tool (2). The control apparatus can be connected to a first pressure line (20) and to a second pressure line (21) of a control device to be operated manually, by which control device the flow rate at the first tool (1) and at the second tool (2) can be changed. The novel control device includes a control valve (7) provided jointly for the first and second supply circuits (3, 4) as the control device, the control valve (7) has three switching positions: (a) the flow rate from the first pressure line (20) is available only to the first tool (1) and the flow rate from the second pressure line (21) is available only to the second tool (2), (b) the flow rate from the first and second pressure lines (20, 21) is available to the first tool (1), (c) the flow rate from the first and second pressure lines (20, 21) is available to the second tool (2).

### SUBJECT MATTER OF THE INVENTION

The present invention relates to a control device and/or regulation unit according to the preamble of claim 1.

### TECHNOLOGICAL BACKGROUND

Such control units are used, by way of example, for operating multiple tools in parallel, such as a rescue cutter and a rescue spreader, for example. The operator in this case actuates the control unit according to the commands of further operators who in turn are operating the individual tools connected to the control unit. By way of example, in an automobile accident, one member of the rescue team operates the control unit, whereas another member of the rescue team cuts through, for example, the roof cladding of the crashed vehicle directly next to the vehicle, by means of a rescue cutter, and another member of the rescue team attempts to make more room inside the crashed vehicle for the actual rescue, for example of a passenger trapped inside, by means of a rescue spreader. For such uses, good operability of the control unit is particularly important.

### CLOSEST PRIOR ART

A control unit according to the preamble of claim 1 is known from EP 1 084 349 B1. The control unit has two separate control valves arranged in a common valve block for the selective operation of two tools at higher energy consumption, and each of these control valves are operated by hand by the operator. Both control valves are connected via a common connection channel which is likewise situated in the valve block. This known control unit therefore has a complex construction. In addition, operability of the unit is not optimum, for the following reasons: each control valve has three switch positions. As such, a total of nine different switch position options results for each of the control valves—particularly the operating levers thereof. In practice, this leads to a situation where the operator must move the operating lever of both control valves in the required manner. Because malfunction behavior can result in certain positions of the operating levers with respect to each other, in actual practice further precautions are taken to protect these positions of the operating levers, said precautions consisting of auxiliary mechanical means (e.g. chains which restrict the movement of both operating levers to certain ranges).

EP 1 286 058 B1 shows a hydraulic system for injection molding systems, wherein it is possible to direct the output pressure from at least two variable pumps by switching to at least one consumer, either individually or in groups. In any case, two valves must be operated in this configuration.

A hydraulic two-circuit system for controlling multiple consumers is known from WO 2009/129942 A1, wherein an interconnecting valve arrangement works together with an additional deactivation device to switch from one circuit to the other circuit.

### PROBLEM ADDRESSED BY THE PRESENT INVENTION

The problem addressed by the present invention is that of providing a control unit of the indicated type, which offers a simplified construction and a higher degree of operating comfort.

### SUBJECT MATTER OF THE INVENTION

The problem above is addressed by the control unit of the indicated type, having the features of the characteristic part of claim 1.

Practical embodiments of the invention are claimed in the dependent claims.

Because only one single control valve is included in the configuration as the control device for the first and second supply circuits, the configuration achieves—on the one hand—a simplified operability due to the fact that the operator only needs to operate this control valve. In contrast to the prior art, the operator therefore only needs to select 3 switch positions, using one hand. Accordingly, it is possible to switch the line capacity of the two pressure feeds selectively, either to the tools independently of each other, or to one of the tools with preference. In addition, no mechanical protection is required. On the other hand—the configuration simultaneously makes it possible to simplify the construction of the control unit. The complexity of the construction is very significantly reduced.

Each of the pressure feeds is advantageously connected to a separate, associated unit which produces pressure.

The control valve advantageously has an operating element, for example in the form of a selection lever or the like, for manual operation.

As an alternative, the control valve could also be driven electrically, for example via an electric motor, if required.

According to one advantageous embodiment, the return feed of the pressure medium from each supply circuit to the tank is designed to bypass the control valve. In this way, the configuration enables a throttle-free return, in contrast to a return feed through the control valve. In addition, the control valve can be produced in a simpler and therefore more cost-effective manner.

According to one embodiment of the present invention, the total line capacity can be selectively switched either to the first or to the second tool. Accordingly, it is possible to selectively switch the line capacities of the two pressure lines either independently to the tools, or completely and preferentially to one of the tools.

According to a further, special embodiment of the present invention, the switching of the line capacity can be realized according to the position of the control valve in the manner of a proportional valve, in a controllable manner. This embodiment in particular is easy to implement, due to the simple construction of the control unit according to the invention.

The control valve advantageously has no bypass and/or zero-pressure switch position, wherein the pressure generated in the devices for the purpose of pressure generation is fed back to the tank, such that no pressure is present at the tool. This simplifies the construction of the control valve.

Couplings are preferably positioned between the control valve and each of the tools, wherein the couplings have so-called bypass functions. In this case, the couplings are coaxial coupling systems which directly connect the pressurized end of the hose to the discharge end in the region of the coupling connection, when in the uncoupled state. In this manner, the configuration achieves a simple zero-pressure setting in each of the supply circuits.

In addition or as an alternative thereto, each supply circuit can include an associated outlet valve. This outlet valve ensures an additional option for releasing pressure.

The control valve is advantageously housed in a transportable, meaning mobile, valve block which can be loaded onto the freight bed of a tractor trailer or the like when necessary, for instance. The valve block is preferably portable such that the option also exists of using the control unit according to the invention in isolated and/or difficult to access places, such as directly at the site of collapsed buildings, crashed cars, etc. —such that the operators can easily communicate.

The construction according to the invention also makes it possible, due to the constructive simplicity [of the configuration] and the use of only one single control valve, to connect multiple such control valves to each other to add security for the control device, thereby making it possible to increase the number of tools in proportion to the number of the control valves.

It is also possible to conceive the control valve according to the present invention in such a manner that more than two tools, and for example 3 tools, can be controlled via the control valve. In this case, it is also possible to advantageously include a corresponding number of pressure-generating units.

To improve manageability, the couplings can be integrated into the valve block.

The valve block can advantageously be connected to each of the pressure generating units via hose connections or tube connections, and accordingly to the tools.

As an alternative, each pressure generating unit can be an integral component of the valve block.

### ADVANTAGEOUS EMBODIMENTS OF THE INVENTION

Advantageous embodiments of the present invention are described in greater detail below with reference to schematic drawing figures, wherein:

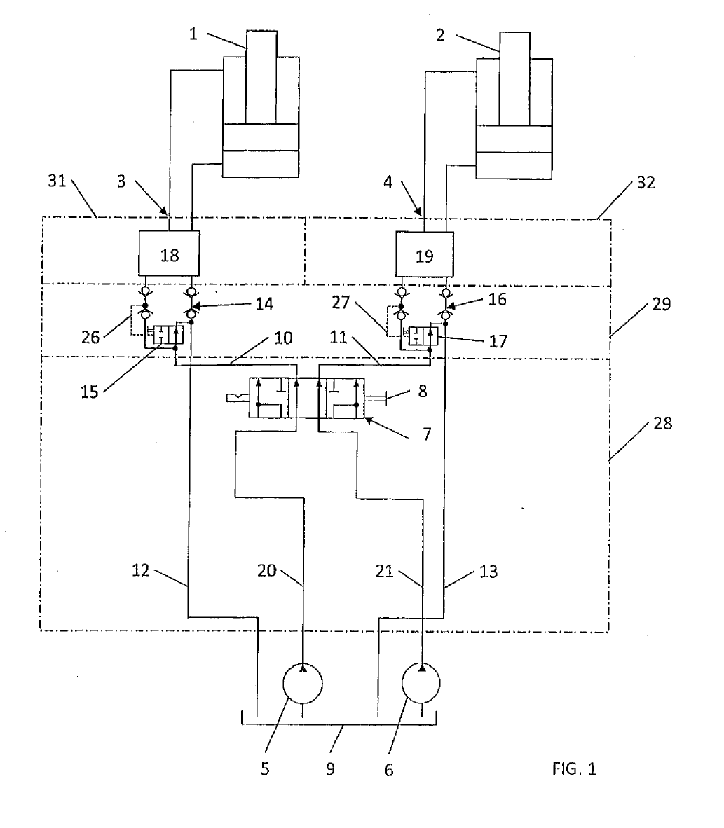

FIG. 1 shows a first embodiment of a circuit diagram of a complete assembly which utilizes the control unit according to the invention;

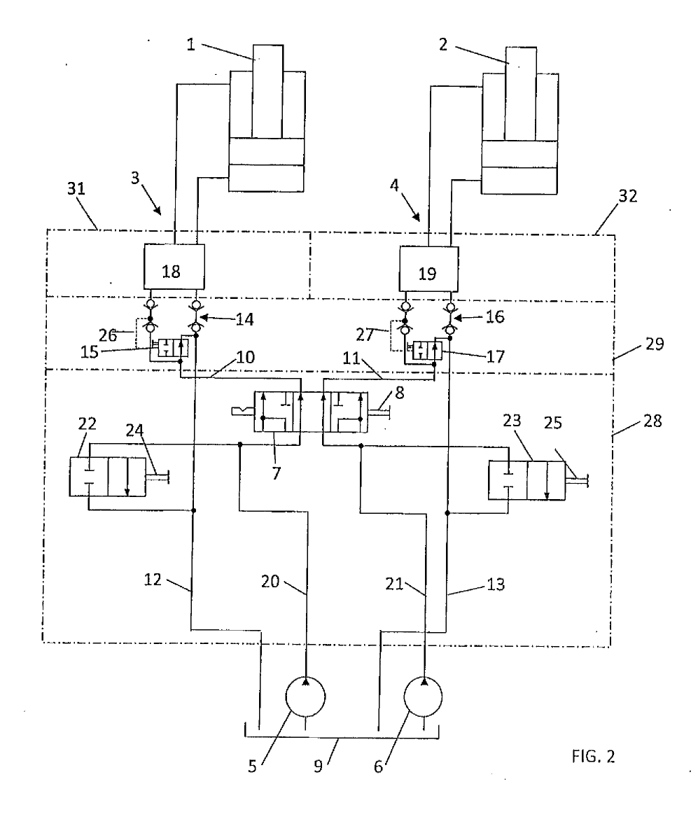

FIG. 2 shows a further embodiment of a circuit diagram of a complete assembly which utilizes the control unit according to the invention;

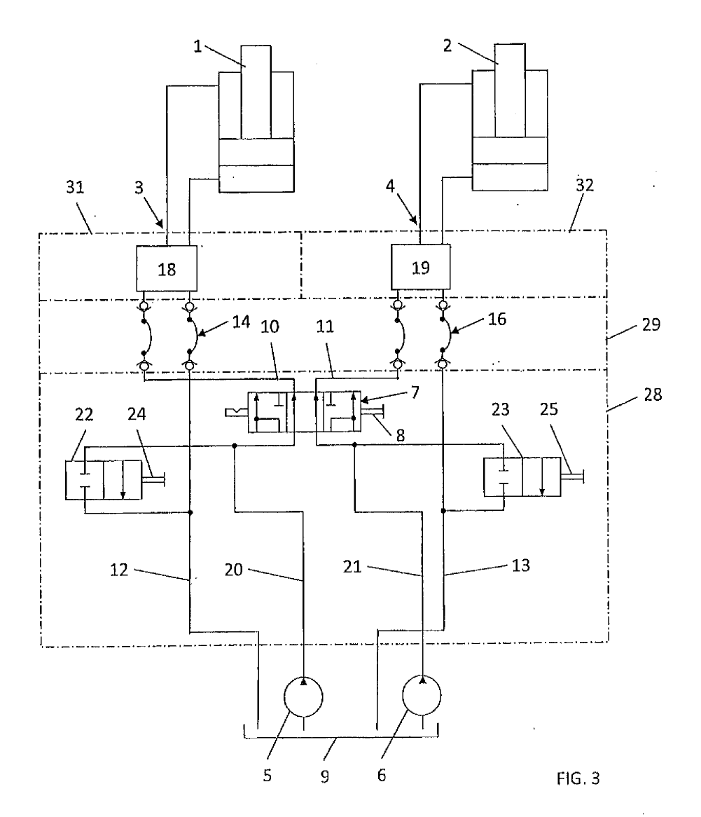

FIG. 3 shows a further embodiment of a circuit diagram of a complete assembly which utilizes the control unit according to the invention;

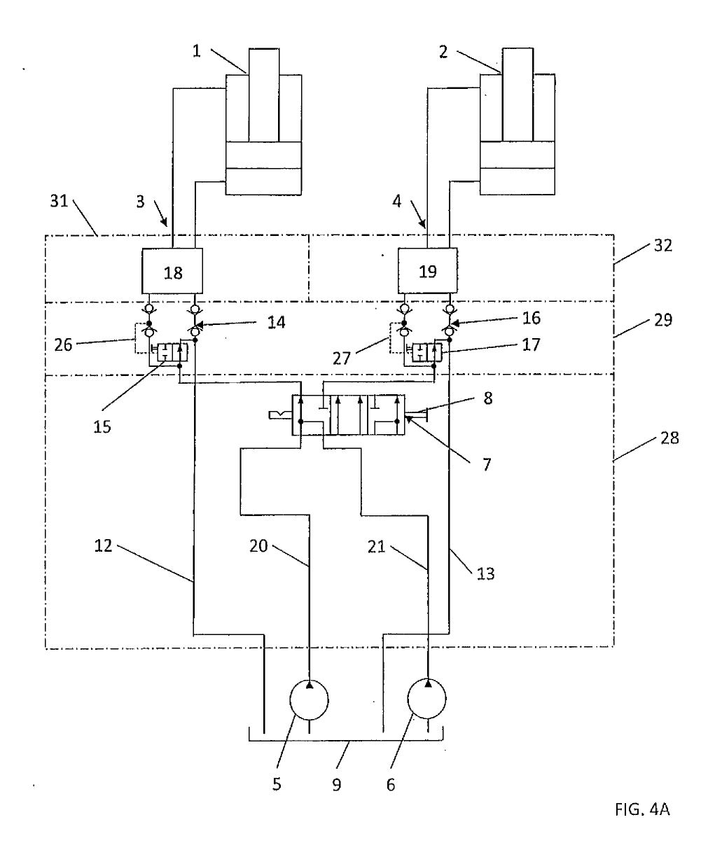

FIG. 4 shows an illustration of the first circuit position (FIG. 4A) and the third circuit position (FIG. 4B) of the circuit diagram in FIG. 1;

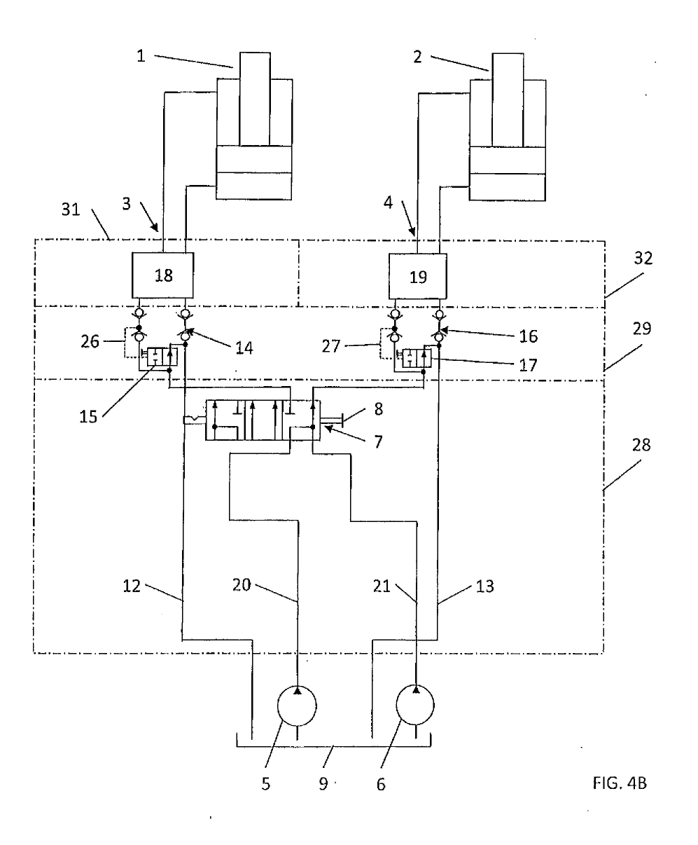

FIG. 5 shows an illustration of a circuit diagram having a cascaded arrangement of multiple control valves, and,

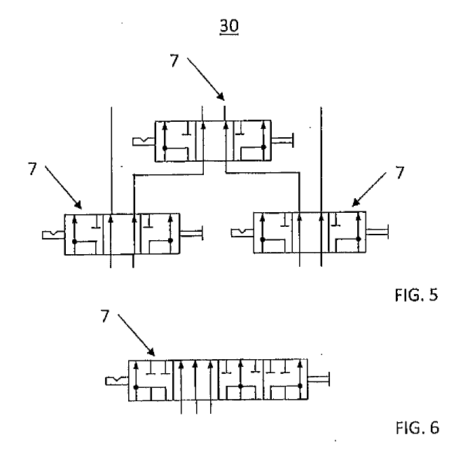

FIG. 6 shows an illustration of the control valve which controls a first, second, and third tool.

The reference numbers 1 and 2 in FIG. 1 indicate a first and/or a second tool, for example a rescue cutter and a rescue spreader. The first tool 1 is supplied with pressure medium, for example hydraulic oil, via a first supply circuit 3, and the second tool 2 is supplied via a second supply circuit 4. A first control valve 18 and a second control valve 19 are connected via a pressure line and a discharge line to the first and second tools 1, 2, respectively, for the control of the two tools 1, 2. The control valve 18, 19 serves the purpose of interrupting the feed of pressure to the tool 1, 2, or switching the direction of the pressure feed, if required.

The control valves 18, 19 can be housed in an associated valve block 31 and/or 32 if necessary, as illustrated in FIG. 1.

The generation of pressure is realized via a first 5 and a second 6 pressure generating unit (for example hydraulic pumps), both of which are connected to a common tank 9 or, if required, to separate tanks, and both of which are connected to the control valve 7. The units 5 and/or 6 are connected to the control valve 7 via a first pressure line 20 and a second pressure line 21. The first pressure line 20 and the second pressure line 21 have the control valve 7 on the ends thereof, wherein said control valve [7] in the embodiment illustrated in FIG. 1 has only three switch positions, and these can be selected by an operator via an operating element 8. Each switch position is preferably secured in the selected switch position via removable locking means.

The switch positions of the control valve 7 are as follows (cf. FIGS. 4A and 4B as well):
(a) the line capacity from the first pressure generating unit 5 is exclusively available to the first tool 1 and the line capacity from the second pressure generating unit 6 is exclusively available to the second tool 2, (FIG. 1),
(b) the line capacity from the first and the second pressure generating units 5, 6 is available with preference to the first tool 1 (FIG. 4A),
(c) the line capacity from the first and the second pressure generating units 5, 6 is available with preference to the second tool 2 (FIG. 4B).

The control valve 7 is a component of the valve block 28. The control valve 7 has two switch positions functioning as additive positions for the feed capacity of the first and second pressure generating means, as well as one further switch position in which the feed capacity of the associated pressure generating unit is exclusively assigned to the associated tool (central position of the control valve 7 in FIG. 1). Return feeds 12, 13 to the tank 9 are included in the valve block 28. These bypass the control valve 7 rather than returning via the same.

A coupling unit 29 which includes multiple couplings 14, 16 is integrated onto the upper side of the valve block 28, opening toward the upper side thereof. The first and second supply circuits 2, 3 each include a first and/or second coupling 14 and 16, respectively, each of which has a bypass function 15 and/or 17 in the uncoupled state in the embodiment represented in FIG. 1. Upon the uncoupling of the coupling 14 and/or 16, the pressure line 20 and/or 21 is switched to connect to the tank 9 via the bypass switch position of the return feed 12 and/or 13, as shown in FIG. 1. As such, no feed capacity generated by the respective pressure generating unit is applied at the affected tool 1, 2.

The control valves 18, 19 illustrated in FIG. 1 are likewise advantageously each disposed in an associated valve block 31, 32. Each valve block 31, 32 is situated directly next to the associated tool 1 and/or 2. The control valves 18, 19 function to switch on and switch off the feed capacity, and to reverse the working direction of each tool.

In the embodiment shown in FIG. 2, in addition to the constructive features in FIG. 1, a first and second outlet valve 22 and/or 23 is functionally assigned to its respective pressure generating unit 5 and/or 6. Each of the two outlet valves 22, 23 is equipped with its own operating element 24, 25.

By means of the outlet valves 22, 23, it is possible to remove an unforeseen increase in pressure arising in the system, as required, in a simple manner, wherein such an increase in pressure can have various different causes.

The remaining features shown in FIG. 2 correspond to the features of the overall assembly in FIG. 1.

In the construction shown in FIG. 3, rather than a coupling 14, 16 with a bypass function 15, 17, such a coupling having no bypass function is shown. Here as well, the first and second outlet valves 22, 23 are included in the construction.

FIG. 4A shows the control valve 7 in the switching arrangement as in FIG. 1, in the first switch position (left switch position), wherein both the feed capacity of the first pressure generating unit 5, and the feed capacity of the second pressure generating unit 6, are directly connected to the first supply circuit 3 through the single control valve 7, as per the switch position, such that when the coupling 14 is closed and the bypass function 15 is inactive, the sum of both feed capacities is functionally directed to the first tool 1.

The switch position is held in position by a lock mechanism or by a control line 26. The coupling 16 on the tool 2 can remain in bypass [mode] if the feed capacity is connected to tool 1. The opposite applies equally.

FIG. 4B shows the control valve 7 of the circuit arrangement in FIG. 1 in the third switch position (right switch position), wherein the feed capacity of the first pressure generating unit 5, as well as the feed capacity of the second pressure generating unit 6, are both directly connected to the second supply circuit through the control valve 7 as per the switch position, such that the sum of the two feed capacities is functionally directed to the second tool 2 if the coupling 16 is closed and the bypass function 17 is inactive. The switch position is secured by a lock mechanism or by a control line 27.

In FIG. 4A and FIG. 4B, the switch function of the coupling 14, 16 is additionally illustrated with an active bypass function 15, 17—meaning with the coupling 14, 16 in the uncoupled state.

The remaining circuit features in FIGS. 4A and 4B correspond to those in FIG. 1, which illustrates the central (second) switch position of the control valve 7. In the final switch position, each of the line capacities of the respective pressure generating devices 5 and/or 6 is exclusively functionally directed to the associated tool 1 and/or 2, such that both tools 1, 2 each individually receive the full capacity of the pressure generating unit 5 and/or 6 in question.

In place of the control valve 7 shown in FIGS. 1, 4A, and 4B, a control valve having proportional characteristics can also be used. In this case, it is possible to undertake a control of the distribution of the feed capacity to one or the other tool according to the position of the control valve.

FIG. 5 shows an arrangement of multiple control valves 7 in a manner of cascade 30, wherein the pressure medium is—on the one hand—directly supplied to the (not illustrated) tools via two control valves arranged parallel to each other; and on the other hand it is possible to control two additional (likewise not illustrated) tools via an additional control valve. Such cascades 30 can be designed in a variety of ways.

The present invention also enables the control, by means of the control valve 7, of not only a first and second tool 1 and/or 2, but also multiple tools, for example three—as can be seen in the modified control valve 7 visible in FIG. 6. This control valve includes, by way of example, a total of three line sections.

It is hereby expressly noted that the combination of individual features, as well as partial features, of the embodiments shown in FIGS. 1-6, is also considered essential to the invention.

1. A control unit for a first and a second tool, the control unit operated by hydraulic oil, comprising:
a first supply circuit for the first tool and a second supply circuit for the second tool,
wherein the control unit is connectable to, a first pressure line and a second pressure line,
a control device, for modifying line capacity at the first tool and at the second tool,
a control valve comprising a single control device for both the first and second supply circuits,
the control valve having three switch positions:
the line capacity from the first pressure line is exclusively available to the first tool and the line capacity from the second pressure line is exclusively available to the second tool,
the line capacity from the first and the second pressure lines is available to the first tool,
the line capacity from the first and the second pressure lines is available to the second tool;
wherein the tools are tools which can be operated separately by a user, and
the control device is a control device which is operated manually,
the switch position of the control valve can be actuated manually by a single operating element,
couplings are included between the control valve and the first and second tools,
the control valve is housed in a portable valve block, and
the valve block is connectable to the tools via hose connections.

2. A control unit according to claim 1, wherein
the return feed of the pressure medium of the first supply circuit and/or the return feed of the pressure medium of the second supply circuit proceeds from each of the tools to a reservoir, bypassing the control valve.

3. A control unit according to claim 1, wherein
the line capacity of the first and second pressure lines is completely available to the first tool,
the line capacity of the first and second pressure lines is completely available to the second tool.

4. A control unit according to claim 1, wherein
the line capacity of the first and the second pressure lines is available, in a controlled manner, to the first tool according to the position of the control valve,
the line capacity of the first and the second pressure lines is available, in a controlled manner, to the second tool according to the position of the control valve.

5. A control unit according to claim 1, wherein
the control valve lacks a switch position which halts the supply to both the first tool and the second tool.

6. A control unit according to claim 1, wherein
the first supply circuit has a first outlet valve and/or the second supply circuit has a second outlet valve.

7. A control unit according to claim 1, wherein
a plurality of control valves are connected to each other to form a cascade.

8. A control unit according to claim 1, wherein
the control valve is configured such that more than two tools can be controlled via the control valve.

9. A control unit according to claim 1, wherein
the coupling is integrated into the valve block.

10. A control unit according to claim 1, wherein
the couplings are couplings with a bypass function between the supply and return feeds; and
the valve block is connectable to the tools via hose connections.

11. A control unit for a first and a second tool operated by a pressure medium, comprising:
a first supply circuit for the first tool and a second supply circuit for the second tool,
wherein the control unit is connectable to, a first pressure line and a second pressure line,
a control device, for modifying line capacity at the first tool and at the second tool,
a control valve comprising a single control device for both the first and second supply circuits,
the control valve has three switch positions:
the line capacity from the first pressure line is exclusively available to the first tool and the line capacity from the second pressure line is exclusively available to the second tool,
the line capacity from the first and the second pressure lines is available with preference to the first tool,
the line capacity from the first and the second pressure lines is available to the second tool; wherein
a first control valve is connected to the first tool, and a second control valve is connected to the second tool, both via a pressure line and a discharge line, to interrupt pressure feed or to change direction of the pressure feed,
the control device is a control device which is operated manually,
the switch positions of the control valve can be actuated manually by a single operating element,
couplings are included between the control valve and the first and second tools,
the control valve is housed in a portable valve block, and
the valve block is connectable to the tools via hose connections.
